(19) United States
(12) Patent Application Publication
(10) Pub. No.: US 2004/0131442 A1
(43) Pub. Date: Jul. 8, 2004

(54) Clamping piece of springy sheet metal

(75) Inventor: Volker Dieckmann, Bad Berleburg (DE)

Correspondence Address: BANNER & WITCOFF, 1001 G STREET N W, SUITE 1100, WASHINGTON, DC, 20001, US

(73) Assignee: EJOT GmbH & Co. KG, Bad Laasphe (DE)

(21) Appl. No.: 10/689,838

(22) Filed: Oct. 22, 2003

(30) Foreign Application Priority Data
Jun. 12, 2002 (DE) 102 26 119.9

(51) Int. Cl. F16B 39/284

(52) U.S. Cl. 411/112

(57) ABSTRACT

The invention relates to a clamping piece of springy sheet metal with two opposing, V-shaped latching recesses and a spring bottom connecting the latching recesses, said spring bottom having in its middle a hole for receiving a screw for securing a component to a panel, wherein, for latching into a penetration in the panel, the latching recesses are of such depth that, with the clamping piece in the latched position, their arms encompass the edges of the penetration on both sides in such a manner that the spring bottom maintains a distance from the panel. Provided between spring bottom and component is a supporting part, wherein, when pressure is exerted on the spring bottom, said supporting part holds the spring bottom at a minimum distance from the component through supporting of the supporting part on the component.

The invention relates to a clamping piece of springy sheet metal with two opposing, V-shaped latching recesses and a spring bottom connecting the latching recesses, said spring bottom having in its middle a hole for receiving a screw for securing a component to a panel.

A similar clamping piece is published in DE 197 30 870 A1. The known clamping piece is used to secure slotted stone elements to a subsurface. For this purpose, the clamping piece is secured to the subsurface by means of a screw, the screw being introduced from the side of the latching recesses into the hole in the spring bottom connecting the two latching recesses. Thereupon, the stone element can be pressed against the clamping piece, wherein the latching recesses thereof penetrate into the slots in the stone element and become jammed therein.

Further known from U.S. Pat. No. 1,881,836 is a clamping piece which is used for securing a component to a panel. Said clamping piece is latched into a penetration in the panel, for which purpose the latching recesses of the clamping piece are of such depth that, with the clamping piece in the latched position, their arms encompass the edges of the penetration on both sides, the spring bottom maintaining a distance from the panel. When a screw is screwed into said clamping piece from the side of the component, the head of said screw then drawing the component to the panel, then also the spring bottom of the clamping piece is drawn more or less between the latching recesses, as a result of which, through the tightening of the screw, there results a high contact pressure between panel and component.

The object of the invention is to design such a clamping piece such that, with the ends of its arms, said clamping piece contacts the component with a defined pressure, said pressure still allowing the clamping piece together with the component to be moved within the size of the penetration. The object of the invention is achieved in that provided between spring bottom and component is a supporting part, wherein, when pressure is exerted on the spring bottom, said supporting part holds the spring bottom at a minimum distance from the component through supporting of the supporting part on the component.

The clamping piece of springy sheet metal permits insertion into the penetration in the panel in such a manner that the latching recesses are pressed together, as a result of which the spring bottom becomes curved, with the consequence that the clamping piece can be inserted effortlessly into the penetration. After the arms of the latching recesses have been released, they spread apart, with which the operation of latching into the penetration in the panel is completed. In order to enable the spring bottom, the hole of which receives a screw, to produce a defined clamping force with respect to the panel, a supporting part is provided between the spring bottom and the component, said supporting part maintaining a minimum distance between the spring bottom and the component. When the screw is tightened, the component is drawn to the panel and the component is permanently pressed against the panel with defined tension. Consequently, there is a stable connection between panel and component, said connection being guaranteed by the easy-to-use clamping piece. Said defined tension guarantees the possibility of movement within a rectangular penetration of a length greater than the width of the arms of the latching recesses, it being possible to use said possibility of movement in order to compensate for tolerances (e.g. if the component becomes hot). However, if the penetration is of a length which is equivalent to the width of the arms of the latching recesses, then the position of the clamping piece in relation to the panel is immovably fixed.

With regard to the design of the supporting part, there are various, advantageous possibilities. For example, the spring bottom may be provided with at least one supporting lobe, wherein said supporting lobe(s) issue from the middle of said spring bottom and transversely with respect to the longitudinal extent thereof and form the supporting part. Conversely, it is possible for the supporting part to be bent out of the latching recess towards the spring bottom, this likewise fixing the distance between the spring bottom and the component. A further possibility is for the supporting part to be in the form of a tubular rail drawn out of the spring bottom. A similar design is achieved if injected into the hole in the spring bottom is a plastic tubular piece forming the supporting part. There is once again a similar design to this, namely if connected in form-fitting manner to the hole in the spring bottom is a sheet-metal tubular piece forming the supporting part.

To enable the spring characteristics of the clamping piece to be exploited to particularly good effect, the spring bottom is advantageously arched in form.

Example embodiments of the invention are shown in the drawings, in which:

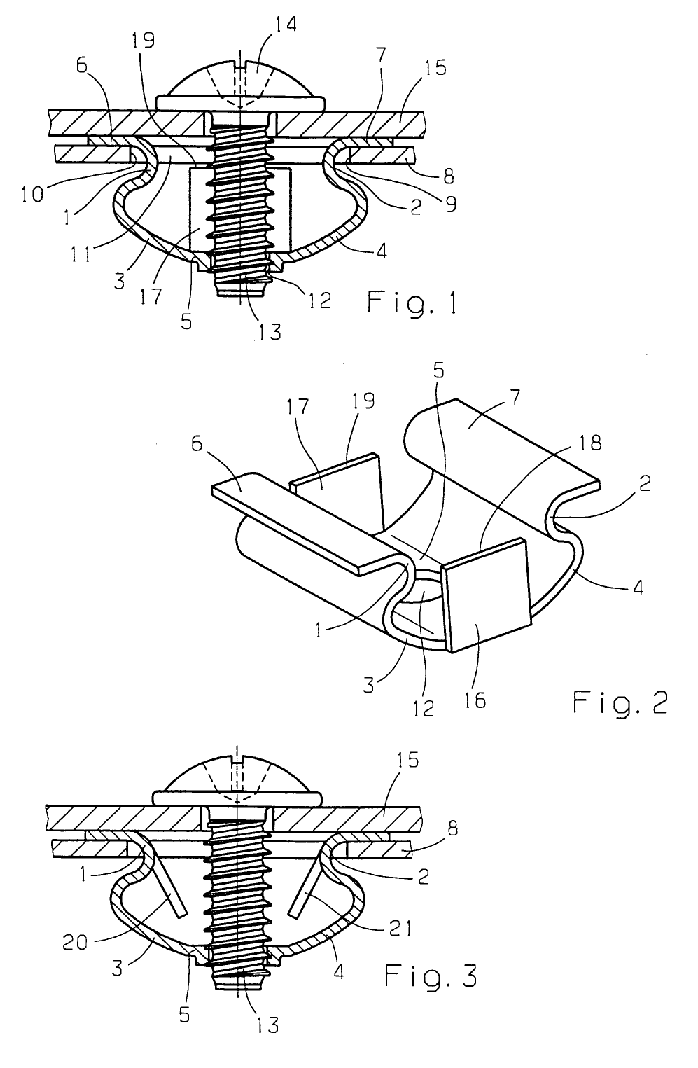

FIG. 1 shows the clamping piece, latched into a panel with thereto secured component in a side view;

FIG. 2 shows the same clamping piece alone in a perspective view;

FIG. 3 shows the clamping piece alone with a supporting part, said supporting part being bent out of the latching recess towards the spring bottom;

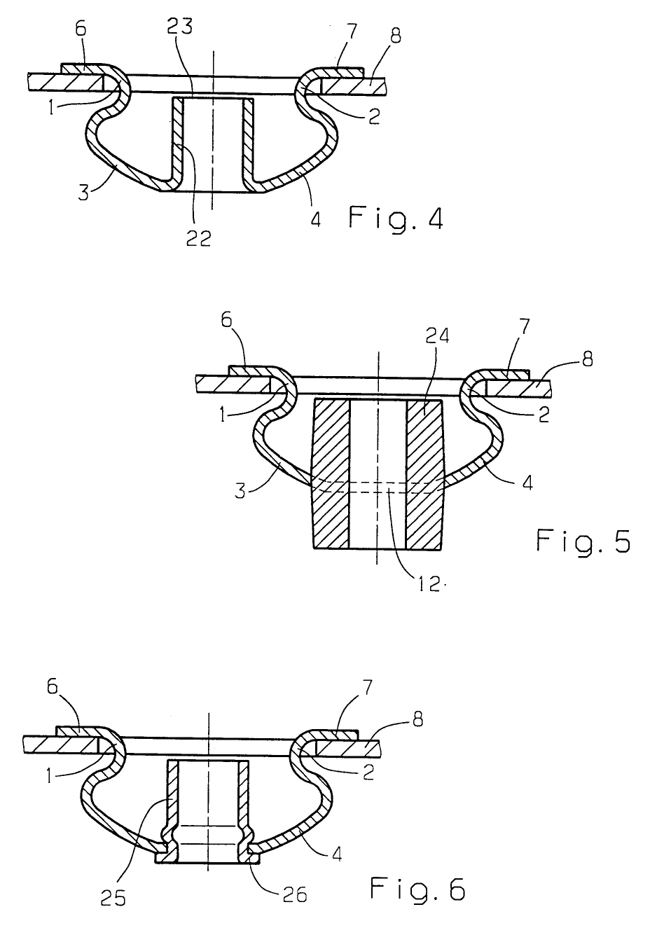

FIG. 4 shows the clamping piece alone with tubular rail drawn out of the spring bottom;

FIG. 5 shows a design with plastic tubular piece forming the supporting part;

FIG. 6 shows the clamping piece alone with a sheet-metal tubular piece connected in form-fitting manner to the hole in the spring bottom.

The clamping piece shown in FIG. 1 has the two opposing latching recesses 1 and 2, which transition via their arms 3 and 4 into the arched spring bottom 5. The two latching recesses 1 and 2 are approximately V-shaped in form. The ends 6 and 7 of their arms engage behind the panel 8. On the side of the panel 8 opposite the ends 6 and 7, the latching recesses 1 and 2 continue in such a manner that the edges 9 and 10 of the penetration 11 are encompassed by the latching recesses 1 and 2, which are, for this purpose, of appropriately deep design. The clamping piece is made of springy sheet metal, e.g. springy sheet steel, with the result that the latching recesses 1 and 2 can be bent together by an appropriate distance for insertion of the spring bottom 5 and the arms 3 and 4 into the penetration 11 in the panel 8. The spring bottom 5 of the clamping piece is provided with a hole 12 for receiving the screw 13, said screw 13 fitting into a corresponding thread in the hole 12. The head 14 of the screw 13 is situated behind the component 15 which is to be secured to the panel 8 by means of the clamping piece. With the clamping piece in the position shown, it is still in the relaxed state in relation to the screwed-in screw 13. When the screw 13 is screwed in further, it draws the spring bottom 12 towards the panel 8, as a result of which the entire securing system shown in the figure is held under tension.

When the screw 13 is further tightened, the spring bottom 5 is, as stated, drawn to the panel 8, wherein the supporting lobes 16 (see FIG. 2 for supporting lobe 17), which issue from the middle of the spring bottom 5, approach the component 15 with their abutting edges 18 (see FIG. 2 for abutting edge 19) and finally support themselves against the component 15, the supporting lobes projecting through the penetration 11 in the panel 8. The supporting of the abutting edges 18 and 19 against the component 15 results in the function of a supporting part with which the distance between spring bottom 5 and component 15 is adjusted to the length of the supporting lobes 16 and 17 and the corresponding distance is thus maintained with defined tension of the latching recesses 1 and 2.

FIG. 2, which presents the clamping piece from FIG. 1 in a perspective view, clearly shows the overall design of the clamping piece. It is apparent from FIG. 2 that the clamping piece is provided with the two supporting lobes 16 and 17, which act as a supporting part and which protrude from the middle of the spring bottom 5 out of the material of the clamping piece, with the result that the clamping piece presented in FIGS. 1 and 2 forms a one-piece element.

FIG. 3 shows an alternative design of the supporting part on the clamping piece in which the supporting parts are bent out of the latching recesses 1 and 2 and the corresponding arms 3 and 4. The two supporting parts 20 and 21 are of such length that, with the screw 13 tightened, they abut the spring bottom 5 and thus correspondingly adjust the distance between component 15 and spring bottom 5. So that sufficient length is obtained for the supporting parts 20 and 21, they are cut centrally out of the latching recesses 1 and 2 and the arms 3 and 4 over a corresponding length and are bent out.

The clamping piece shown in FIG. 4 has a special design of the supporting part, which, in this case, is in the form of a tubular rail 22 which is drawn out of the flat spring bottom 5. The clamping piece shown in FIG. 4 is presented in its relaxed position, in which, therefore, it has not yet been drawn to a component by a screw. When, however, the spring bottom 5 is brought into contact by means of a screw, as shown in connection with FIG. 1, then the leading edge 23 of the rail 22 passes through the penetration 11 shown in FIG. 1 and finally supports itself against the component not shown in FIG. 4 (component 15 in FIG. 1).

FIG. 5 presents a variation on the design shown in FIG. 4. In this case, the supporting part is formed by a plastic tubular piece 24 which is injected into the hole 12 in the flat spring bottom 5. When a screw (not shown) is tightened, the plastic tubular piece 24 performs the same function as the tubular rail 22 shown in FIG. 4.

FIG. 6 presents a further variation on the design of the supporting part. In this case, the supporting part is formed by the sheet-metal tubular piece 25, which is connected in form-fitting manner to the hole 12 in the flat spring bottom 5, such form-fitting connection being accomplished, as shown in FIGS. 5 and 6, by beading the edge 26 of the sheet-metal tubular piece 25, as a result of which a firmly joined element is produced from two parts.

It should further be pointed out that, in the presented example embodiments shown in FIGS. 1 to 3, the spring bottom is arched in form. Such a design facilitates the bending together of the clamping piece during introduction into the penetration in a panel, as described above.

What is claimed is:

1. Clamping piece of springy sheet metal with two opposing, V-shaped latching recesses (1, 2) and a spring bottom (5) connecting the latching recesses (1, 2), said spring bottom (5) having in its middle a hole (12) for receiving a screw (13) for securing a component (15) to a panel (8), wherein, for latching into a penetration (11) in the panel (8), the latching recesses (1, 2) are of such depth that, with the clamping piece in the latched position, their arms (3, 4) encompass the edges (9, 10) of the penetration (11) on both sides in such a manner that the spring bottom (5) maintains a distance from the panel (8), characterized in that provided between spring bottom (5) and component (15) is a supporting part (16, 17; 20, 21), wherein, when pressure is exerted on the spring bottom (5), said supporting part (16, 17; 20, 21) holds the spring bottom (5) at a minimum distance from the component (15) through supporting of the supporting part (16, 17; 20, 21) on the component (15).

2. Clamping piece according to claim 1, characterized in that the spring bottom (5) is provided with at least one supporting lobe (16, 17), wherein said supporting lobe(s) (16, 17) issue from the middle of said spring bottom (5) and transversely with respect to the longitudinal extent thereof and form the supporting part.

3. Clamping piece according to claim 2, characterized in that the supporting part (20, 21) is bent out of the latching recess (1, 2) and the associated arm (3, 4) towards the spring bottom (5).

4. Clamping piece according to claim 1, characterized in that the supporting part is in the form of a tubular rail (22) drawn out of the spring bottom (5).

5. Clamping piece according to claim 1, characterized in that injected into the hole (12) in the spring bottom (5) is a plastic tubular piece (24) forming the supporting part.

6. Clamping piece according to claim 1, characterized in that connected in form-fitting manner to the hole (12) in the spring bottom (5) is a sheet-metal tubular piece (25) forming the supporting part.

7. Clamping piece according to any one of the preceding claims, characterized in that the spring bottom is arched in form.
